(19) United States
(12) Patent Application Publication
(10) Pub. No.: US 2019/0283690 A1
(43) Pub. Date: Sep. 19, 2019

(54) VEHICLE INTERIOR COMPONENT

(71) Applicant: Shanghai Yanfeng Jinqiao Automotive Trim Systems Co. Ltd., Novi, MI (US)

(72) Inventors: Scott Allen Hansen, Holland, MI (US); James Bradley Price, Holland, MI (US); Karl R. Stanley, Holland, MI (US)

(21) Appl. No.: 16/430,976

(22) Filed: Jun. 4, 2019

Related U.S. Application Data
(63) Continuation of application No. PCT/US2018/012225, filed on Jan. 3, 2018.
(60) Provisional application No. 62/443,452, filed on Jan. 6, 2017.

(51) Int. Cl. B60R 13/02; B60Q 3/54; B29C 45/14

(52) U.S. Cl. CPC B60R 13/02; B60Q 3/54; B29L 2031/3041; B32B 2605/003; B60Q 2500/10; B29C 45/14688

(57) ABSTRACT

A component for a vehicle interior with a visible surface is disclosed. The component may comprise a decorative layer coupled to a base and a cover coupled to the decorative layer. The decorative layer may comprise a natural material. The cover may comprise an inner layer comprising a portion preventing visibility of the decorative layer. The decorative layer may comprise a laminate, sheet, veneer or film. The base may comprise a nonplanar surface; inner and outer layers of the cover may be nonplanar; the inner layer of the cover may align with the nonplanar surface of the base. A portion of the inner layer of the cover may prevent illumination to pass from a display to the outer layer of the cover. The cover may comprise an opening to expose or uncover the decorative layer. Visual effects of the decorative layer and cover may provide a composite visual effect.

### CROSS-REFERENCE TO RELATED APPLICATIONS

The present application is a continuation of International/PCT Patent Application No. PCT/US18/12225 titled “VEHICLE INTERIOR COMPONENT” filed Jan. 3, 2018, which claims the benefit of U.S. Provisional Patent Application No. 62/443,452 titled “VEHICLE INTERIOR COMPONENT” filed Jan. 6, 2017.

The present application claims priority to and incorporates by reference in full the following patent applications: (a) U.S. Provisional Patent Application No. 62/443,452 titled “VEHICLE INTERIOR COMPONENT” filed Jan. 6, 2017; (b) International/PCT Patent Application No. PCT/US18/12225 titled “VEHICLE INTERIOR COMPONENT” filed Jan. 3, 2018.

### FIELD

The present invention relates to a vehicle interior component. The present invention also relates to a multi-layer construction of a vehicle interior component.

### BACKGROUND

Components in vehicle interiors are often given a cover intended to protect the component from damage. Such components (and cover) are typically formed from materials that are relatively cost-efficient for production methods (e.g. molded plastics) but may not be fully desired by interior designers wishing to present contoured surfaces (e.g. in forms that are aesthetically integrated) of materials typically considered more pleasing to vehicle occupants.

It would be advantageous to provide an improved component assembly for a vehicle interior that can provide an improved aesthetic opportunity/visual effect. It would also be advantageous to provide improved arrangement for providing a display assembly in a component in a vehicle interior. It would further be advantageous to provide an improved component assembly with contoured surface and improved visual appearance component decorated with materials such as wood, metal, stone, etc. (e.g. decorative, authentic material) but that does not add undesired mass to the vehicle.

### SUMMARY

The present invention relates to a component for a vehicle interior with a surface intended to be visible to an occupant when the component is installed in the vehicle interior comprising a base, a decorative layer coupled to the base and a cover coupled to the decorative layer comprising an outer layer and configured to provide a visual effect. The decorative layer may comprise a natural material configured to provide a visual effect. The cover may comprise an inner layer comprising at least a portion configured to prevent visibility of the decorative layer. The decorative layer may comprise at least one of (a) a laminate; (b) a sheet; (c) a veneer; (d) a film. The base may comprise a nonplanar surface; an inner layer of the cover and the outer layer of the cover may be nonplanar; the inner layer of the cover may be configured to align with the nonplanar surface of the base. The inner layer of the cover may be configured to prevent illumination to pass from a display to the outer layer of the cover; the inner layer of the cover may comprise at least one of (a) ink; (b); paint; (c) a foil; (d) a film; (e) a transparent material; (f) a translucent material; (g) a light-transmissive material. The inner layer of the cover may comprise at least a portion configured to allow illumination to pass from a display to the outer layer of the cover. The cover may comprise an opening configured to at least one of (a) expose the decorative layer; (b) uncover the decorative layer. The cover may comprise at least one of (a) glass; (b) plastic; (c) a transparent material; (d) a light-transmissive material; (e) an opaque material. The component may further comprise an adhesive configured to couple the decorative layer to the cover; the adhesive may be configured to transmit light passing from the cover to the decorative layer. The surface intended to be visible to an occupant may comprise a first portion comprising the cover and a second portion comprising the decorative layer; the visual effect of the decorative layer and the visual effect of the cover may be configured to provide a composite visual effect for the surface intended to be visible to the occupant. The component may further comprise a cover assembly comprising the cover and an inner layer for the cover providing at least one of (a) an electrical circuit; (b) a sensor; (c) a capacitive switch; (d) a capacitive switch sensor.

The present invention relates to a component for a vehicle interior with a surface intended to be visible to an occupant when the component is installed in the vehicle interior comprising a base, a decorative layer coupled to the base and a cover coupled over the decorative layer comprising an outer layer and configured to provide a visual effect. The decorative layer may be configured to provide a visual effect; the visual effect of the decorative layer and the visual effect of the cover may be configured to provide a composite visual effect for the surface intended to be visible to the occupant. The visual effect of the decorative layer may comprise at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral. The visual effect of the cover may comprise at least one of: (a) transparent; (b) translucent; (c) opaque; (d) paint; (e) coating; (f) gradient; (g) transition; (h) shading; (i) material of construction; (j) plastic; (k) molded plastic; (l) contour; (m) surface effect; (n) contour shape; (o) nonplanar shape; (p) speckling; (q) partially transparent; (r) partially translucent; (s) partially opaque. The composite visual effect may comprise a transition between two visual effects. The base may comprise a nonplanar surface; the cover may comprise an inner surface and an outer surface; the inner surface of the cover and the outer surface of the cover may be nonplanar; the inner surface of the cover may be configured to align with the nonplanar surface of the base. The decorative layer may be laminated to the base. The component may further comprise an adhesive configured to couple the decorative layer to the cover; the adhesive may be configured to transmit light from the cover to the decorative layer. The cover further may comprise a film; the film may comprise at least a portion configured to absorb light from a display.

The present invention relates to a method of manufacturing a vehicle trim component configured to provide a composite visual effect comprising the steps of providing a base, joining a decorative layer to the base to create a decorative base and joining a cover to the decorative layer. At least a portion of the cover may be configured to allow illumination to pass from the cover to the decorative base. The composite visual effect may be configured to be provided by a visual effect of the decorative layer and a visual effect of the cover. The cover may comprise an inner layer and an outer layer; at least a portion of the inner layer of the cover may be configured to transmit light passing from a display to the outer layer of the cover. The method may further comprise the step of applying to an inner surface of the cover at least one of (a) ink; (b) paint; (c) a foil; (d) a film; (e) a light-transmissive material; (f) a generally opaque material. At least a portion of the inner layer may be configured to prevent transmission of light passing from the outer layer to the decorative base. The method may comprise the step of applying coating to at least a portion of the cover to create the visual effect of the cover. Joining the cover to the decorative layer may comprise applying an adhesive to at least one of (a) the cover; (b) the decorative layer; the adhesive may be configured to allow illumination to pass from the cover to the decorative base. The visual effect of the decorative layer may comprise at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral.

The present invention relates to a component for a vehicle interior providing a composite visual effect comprising a base, a decorative layer providing a visual effect and a cover providing a visual effect. The decorative layer may be coupled to the base. The cover may be coupled over the decorative layer. The composite visual effect may be provided by the visual effect of the decorative layer and the visual effect of the cover.

The present invention relates to a component for a vehicle interior with a surface intended to be visible to an occupant when the component is installed in the vehicle interior. The component may comprise a base, a decorative layer and a cover. The decorative layer may be coupled to the base. The cover may be coupled to the decorative layer. The cover may comprise an outer layer. The decorative layer may comprise a laminate. The base may comprise a nonplanar surface. The cover may comprise an inner layer. The inner layer of the cover and the outer layer of the cover may be nonplanar. The inner layer of the cover may be configured to align with the nonplanar surface of the base. The decorative layer may comprise a natural material. The decorative layer may be laminated to the base. The component may comprise an adhesive. The adhesive may be configured to couple the decorative layer to the cover. The adhesive may be configured to transmit light passing from the cover to the decorative layer. The cover may comprise glass. The cover may comprise plastic. The outer layer of the cover may comprise at least (a) glass (b) plastic. The inner layer of the cover may comprise at least a portion configured to prevent visibility of the decorative layer. The inner layer of the cover may comprise at least one of (a) ink (b) paint (c) a foil (d) a film configured to prevent illumination to pass from a display to the outer layer of the cover. The inner layer of the cover may comprise at least a portion configured to allow illumination to pass from a display to the outer layer of the cover. The inner layer may comprise at least one of (a) an electrical circuit (b) a sensor (c) a capacitive switch (d) a capacitive switch sensor. The cover may comprise an opening. The opening may be configured to at least one of (a) expose the decorative layer (b) uncover the decorative layer. The surface intended to be visible to an occupant may comprise a first portion comprising the cover and a second portion comprising the decorative layer. The decorative layer may be configured to provide a visual effect. The cover may be configured to provide a visual effect. The visual effect of the decorative layer and the visual effect of the cover may be configured to provide a composite visual effect.

The present invention also relates to a component for a vehicle interior providing a composite visual effect. The component may comprise a base, a decorative layer and a cover. The decorative layer may provide a visual effect. The decorative layer may be coupled to the base. The cover may provide a visual effect. The cover may be coupled over the decorative layer. The composite visual effect may be provided by the visual effect of the decorative layer and the visual effect of the cover. The base may comprise a nonplanar surface. The cover may comprise an inner surface and an outer surface. The inner surface of the cover and the outer surface of the cover may be nonplanar. The inner surface of the cover may be configured to align with the nonplanar surface of the base. The outer surface of the cover may comprise at least one of (a) glass, (b) plastic. The cover may comprise a nonplanar form. The decorative layer may be laminated to the base. The decorative layer may comprise a sheet. The component may comprise an adhesive configured to couple the decorative layer to the cover. The adhesive may be configured to transmit light from the cover to the decorative layer. The visual effect of the cover may comprise at least one of: (a) transparent; (b) translucent; (c) opaque; (d) paint; (e) coating; (f) gradient; (g) transition; (h) shading; (i) material of construction; (j) plastic; (k) molded plastic; (l) contour; (m) surface effect; (n) contour shape; (o) nonplanar shape; (p) speckling; (q) partially transparent; (r) partially translucent; (s) partially opaque. The visual effect of the decorative layer may comprise at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral. The visual effect of the cover may comprise a transition between two visual effects. The cover may comprise a film. The film may comprise at least a portion configured to absorb light from a display.

The present invention further relates to a method of manufacturing a vehicle trim component comprising the steps of providing a base, joining a decorative layer to the base to create a decorative base and joining a cover to the decorative layer. At least a portion of the cover may be configured to allow illumination to pass from the cover to the decorative base. The method may comprise the step of applying at least one of (a) ink (b) paint (c) a foil (d) a film to an inner surface of the cover to create a cover assembly comprising a transparent portion and a partially opaque portion. The cover may comprise an inner layer and an outer layer. At least a portion of the inner layer of the cover may be configured to transmit light passing from a display to the outer layer of the cover. The method may comprise the step of applying at least one of (a) ink (b) paint (c) a foil (d) a film to the outer layer to create the inner layer. At least a portion of the inner layer may be configured to prevent transmission of light passing from the outer layer to the decorative base. The method may comprise the step of applying coating to at least a portion of the cover to create a visual effect. The inner layer of the cover may comprise at least one of (a) an electrical circuit (b) a sensor (c) a capacitive switch (d) a capacitive switch sensor. Joining the cover to the decorative layer may comprise applying an adhesive to at least one of (a) the cover (b) the decorative layer. The adhesive may be configured to allow illumination to pass from the cover to the decorative base. The method may comprise the step of creating an opening in the cover. The opening may be configured to at least one of (a) expose the decorative base (b) uncover the decorative base.

### FIGURES

FIG. 1A is a schematic perspective view of a vehicle according to an exemplary embodiment.

FIG. 1B is a schematic perspective cut-away view of a vehicle showing an interior according to an exemplary embodiment.

FIGS. 2A and 2B are schematic perspective views of a vehicle interior with components according to an exemplary embodiment.

FIG. 3A is a schematic exploded side view of an assembly of a component according to an exemplary embodiment.

FIG. 3B is a schematic side view of the component according to an exemplary embodiment.

FIG. 4A is a schematic exploded side views of an assembly of a component according to an exemplary embodiment.

FIG. 4B is a schematic side view of the component according to an exemplary embodiment.

FIGS. 5A to 5D are schematic side views of an assembly of a component according to an exemplary embodiment

FIGS. 6A to 6D are schematic side views of an assembly of a component according to an exemplary embodiment

FIG. 7A is a schematic exploded side view of an assembly of a component according to an exemplary embodiment.

FIG. 7B is a schematic side view of the component according to an exemplary embodiment.

FIGS. 8A to 8D are schematic side views of an assembly of a component according to an exemplary embodiment.

FIG. 8E is a schematic side view of the component according to an exemplary embodiment.

FIG. 8F is a schematic side view of the component according to an exemplary embodiment.

FIG. 9A is a schematic perspective view of a component according to an exemplary embodiment.

FIG. 9B is a schematic perspective view of a cover of a component according to an exemplary embodiment.

FIG. 9C is a schematic perspective view of a decorative layer of a component according to an exemplary embodiment.

FIG. 10A is a schematic exploded side view of an assembly of a component according to an exemplary embodiment.

FIG. 10B is a schematic side view of the component according to an exemplary embodiment.

FIG. 11A is a schematic exploded side view of an assembly of a component according to an exemplary embodiment.

FIG. 11B is a schematic side view of the component according to an exemplary embodiment.

FIGS. 12A to 12C are schematic side views of an assembly of a component according to an exemplary embodiment.

FIG. 12D is a schematic side view of the component according to an exemplary embodiment.

FIGS. 13A to 13D are schematic side views of an assembly of a component according to an exemplary embodiment.

FIG. 14 is a schematic side view of treatment/assembly of a component according to an exemplary embodiment.

FIG. 15A is a schematic exploded side view of an assembly of a component according to an exemplary embodiment.

FIG. 15B is a schematic side view of the component according to an exemplary embodiment.

FIGS. 16 to 18 are schematic flow diagrams of methods to produce a component assembly according to an exemplary embodiment.

### DESCRIPTION

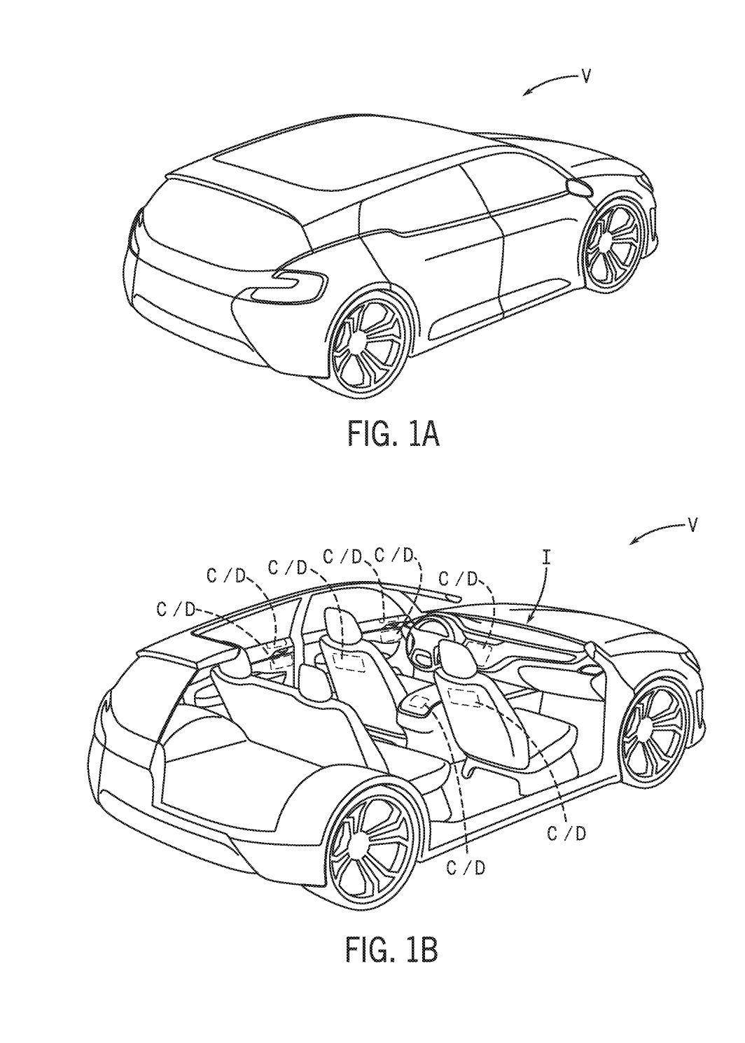

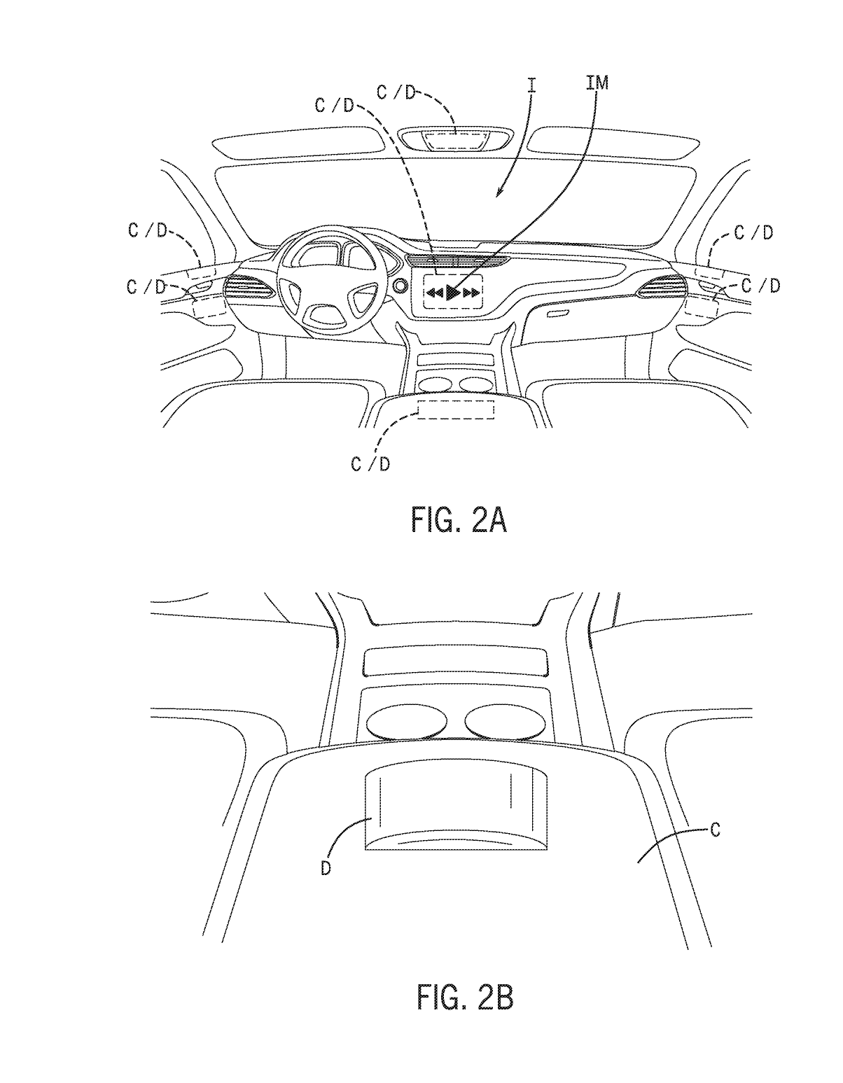

According to an exemplary embodiment as shown schematically in FIGS. 1A and 1B, a vehicle V may include a vehicle interior I. The vehicle interior may provide components C such as panels, consoles, compartments, etc. Components C may provide a display D (e.g. display panel, illumination, data display, display screen, etc.) to present information, alerts, entertainment, data, etc. to a vehicle occupant (e.g. data/information as may be available from various sources such as image IM as shown in FIG. 2A). The vehicle interior may be provided with a variety of display configurations in a variety of positions and locations to serve a variety of purposes. See e.g. FIGS. 1B and 2A-2B.

According to an exemplary embodiment, the component may comprise a trim component, panel, console, etc. provided within the vehicle interior (e.g. instrument panel, door, seat area, cockpit, center area, overhead, etc.). See e.g. FIGS. 1B and 2A-2B.

As indicated schematically according to an exemplary embodiment, the display D of the component may present an image and/or information (e.g. data/information, instrumentation, indicators, controls, entertainment, communications, etc.). See e.g. FIG. 2A. According to an exemplary embodiment, the component C and/or display D (if provided on the component) may provide a contoured form/shape designed/intended to integrate with the interior design/aesthetic of the vehicle V. See e.g. FIGS. 1B and 2A-2B. According to an exemplary embodiment, the component C may be provided with a visual effect and formed (e.g. shaped/contoured). See e.g. FIGS. 1B, 2A-2B and 9A-9C.

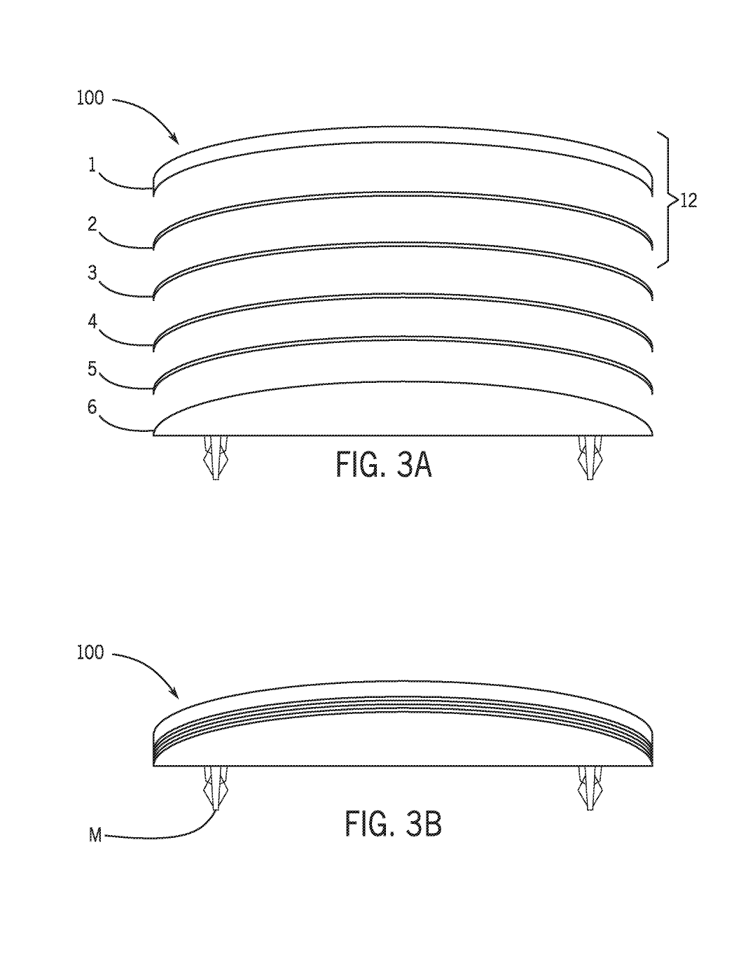

According to an exemplary embodiment as shown schematically in FIG. 3A, a component 100 for a vehicle interior may comprise a surface intended to be visible to an occupant when the component is installed in the vehicle interior. Component 100 may comprise a base 6, a decorative layer or laminate 4 and a cover 12 comprising an outer layer 1. Cover 12 may comprise an inner layer 2. Decorative layer 4 may be coupled to base 6. Decorative layer 4 may be laminated to base 6, or an adhesive 5 may couple decorative layer 4 and base 6. Cover 12 may be coupled to decorative layer 4. Adhesive 3 may couple cover 12 to decorative layer 4. Adhesive 3 may be configured to transmit light passing from cover 12 to decorative layer 4. Decorative layer 4 may comprise a laminate. Base 6 may comprise a nonplanar surface. Inner layer 2 of cover 12 and outer layer 1 cover 12 may be nonplanar. Inner layer 2 of cover 12 may be configured to align with the nonplanar surface of base 6. Decorative layer 4 may comprise a natural material. Cover 12 may comprise glass. Outer layer 1 of cover 12 may comprise glass. Cover 12 may comprise plastic. Outer layer 1 of cover 12 may comprise plastic. Inner layer 2 of cover 12 may comprise at least a portion configured to prevent visibility of decorative layer 4. Inner layer 2 may comprise at least one of (a) an electrical circuit (b) a sensor (c) a capacitive switch (d) a capacitive switch sensor. Decorative layer 4 may be configured to provide a visual effect. Cover 12 may be configured to provide a visual effect. The visual effect of decorative layer 4 and the visual effect of cover 12 may be configured to provide a composite visual effect.

According to an exemplary embodiment as shown schematically in FIG. 3A, a component for a vehicle interior 100 may provide a composite visual effect. Component 100 may comprise a base 6, a decorative layer 4 and a cover 12. Decorative layer 4 may provide a visual effect. Decorative layer 4 may be coupled to base 6. Cover 12 may provide a visual effect. Cover 12 may be coupled over decorative layer 4. The composite visual effect may be provided by the visual effect of decorative layer 4 and the visual effect of cover 12. Base 6 may comprise a nonplanar surface. Cover 12 may comprise an inner surface 2 and an outer surface 1. The inner surface 2 of cover 12 and the outer surface 1 of cover 12 may be nonplanar. The inner surface 2 of cover 12 may be configured to align with the nonplanar surface of base 6. The outer surface 1 of cover 12 may comprise at least one of (a) glass, (b) plastic. Cover 12 may comprise a nonplanar form. Decorative layer 4 may be laminated to base 6. Decorative layer 4 may comprise a sheet. Component 100 may comprise an adhesive 3 configured to couple decorative layer 4 to cover 12. Adhesive 3 may be configured to transmit light from cover 12 to decorative layer 4. The visual effect of cover 12 may comprise at least one of: (a) transparent; (b) translucent; (c) opaque; (d) paint; (e) coating; (f) gradient; (g) transition; (h) shading; (i) material of construction; (j) plastic; (k) molded plastic; (l) contour; (m) surface effect; (n) contour shape; (o) nonplanar shape; (p) speckling; (q) partially transparent; (r) partially translucent; (s) partially opaque. The visual effect of decorative layer 4 may comprise at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral. The visual effect of cover 12 may comprise a transition between two visual effects. Cover 12 may comprise a film 2.

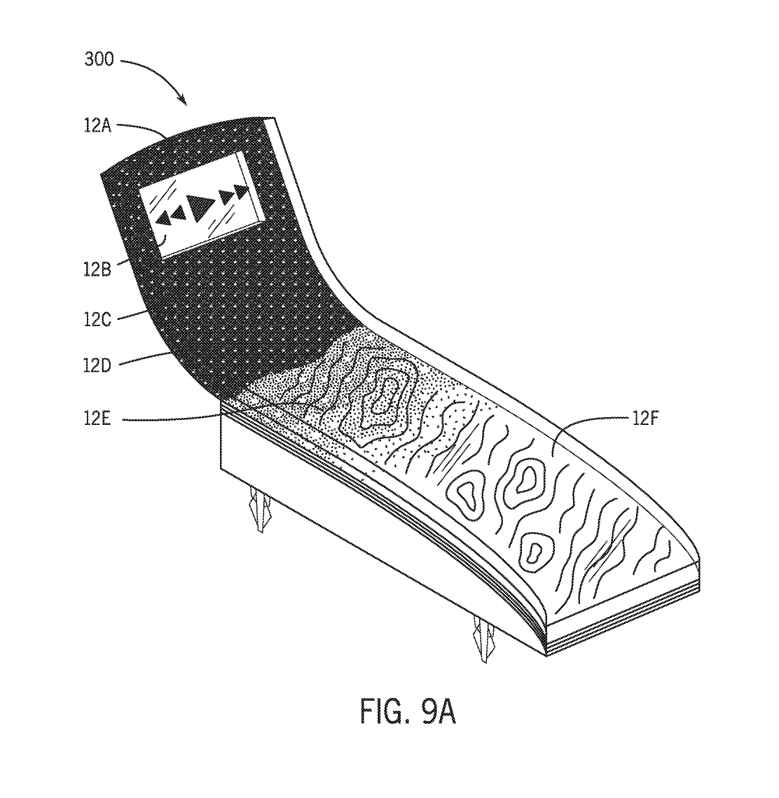

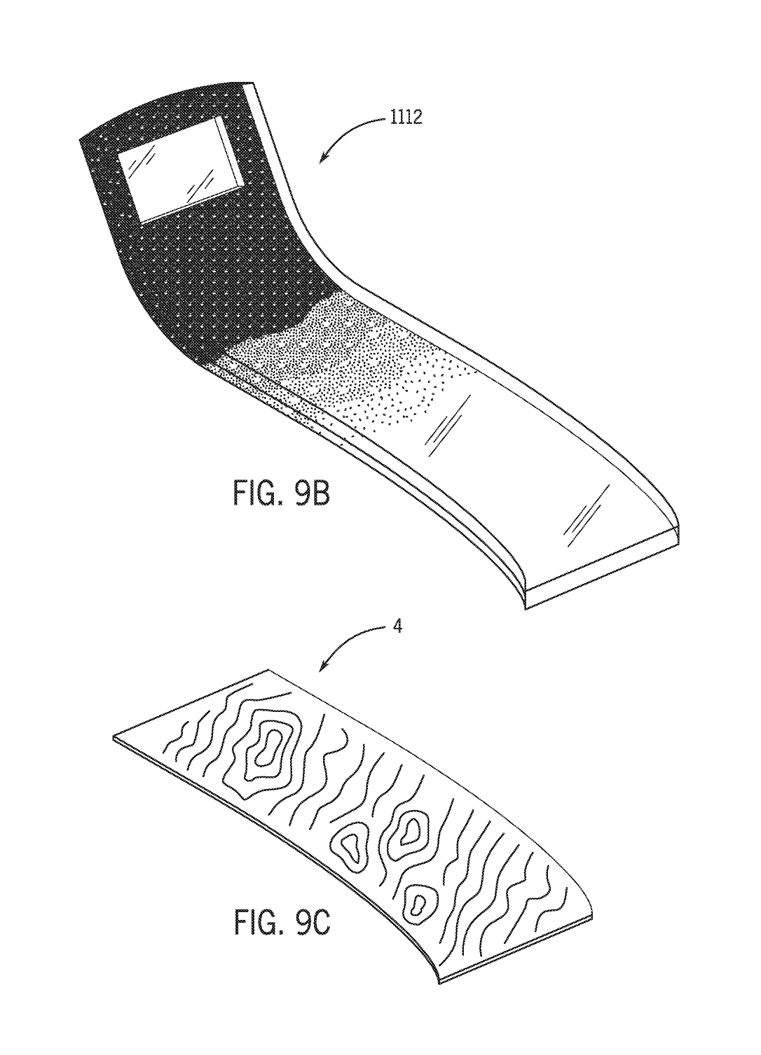

According to an exemplary embodiment as shown schematically in FIG. 3A, the component 100 may comprise a multi-section/multi-layer construction with an outer layer or cover 1 and a sheet material shown as decorative layer 4 that may be provided (e.g. attached, mounted, affixed, installed, etc.) on a base or structure shown as base/substrate 6. See e.g. FIGS. 3B and 9A. As shown schematically in FIGS. 3A and 3B, the cover 12 may be provided with a film layer 2 and attached to the sheet material 4 with an adhesive shown as transparent/optically clear adhesive sheet 3; the sheet material 4 may be attached to the base 6 by an adhesive shown as adhesive sheet 5 to form the component 100. See e.g. FIGS. 2A-2B and 3B.

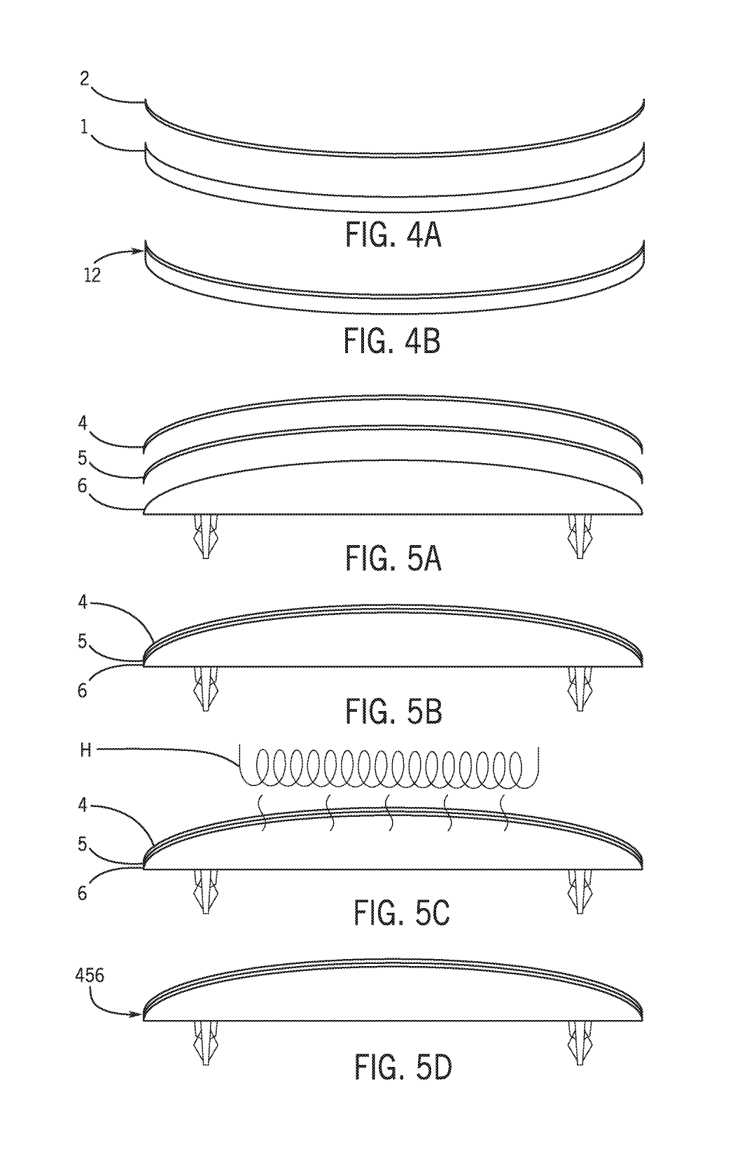

According to an exemplary embodiment as shown schematically in FIGS. 4A and 4B, a cover assembly 12 may be formed for the component by attachment of film 2 (if used) to cover/layer 1. As shown indicated schematically in FIGS. 5A-5D, a base assembly 456 may be formed for the component by attachment of sheet material/decorative layer 4 to the base/substrate 6 with a bond by adhesive 5 (shown as a cured adhesive with curing by heat from a heating element H).

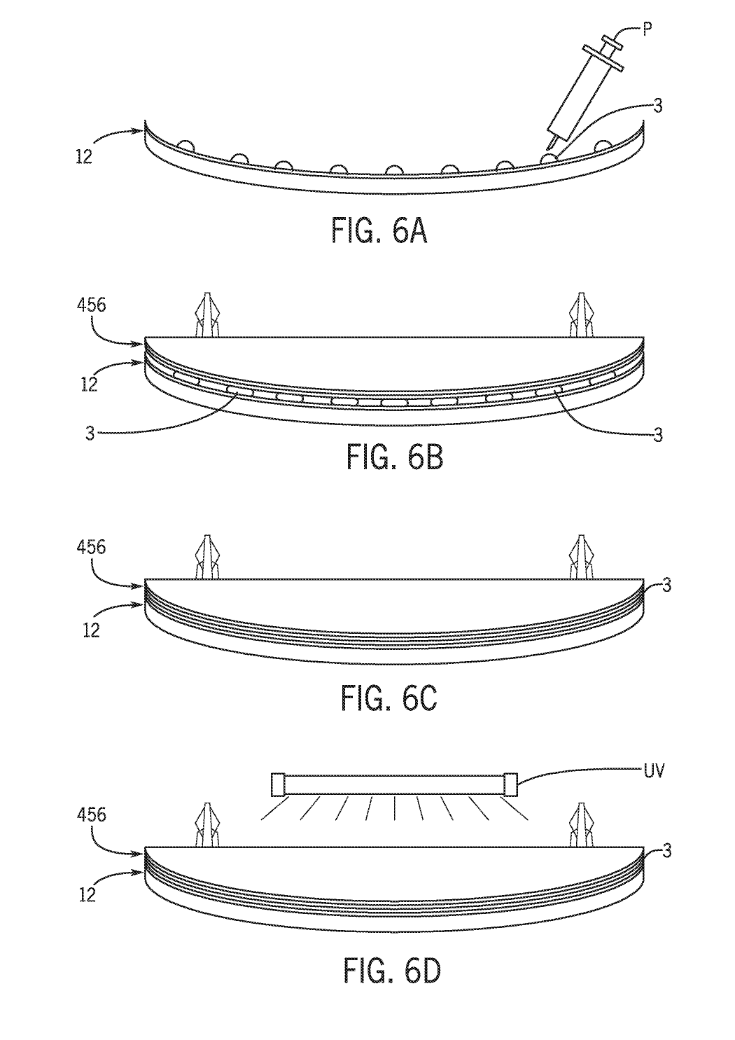

According to an exemplary embodiment as shown schematically in FIGS. 6A-6D, the cover assembly 12 may be attached/bonded to the base assembly 456 by an adhesive shown as (transparent/optically clear) liquid adhesive 3 applied from a dispensing system shown as dispenser P; the adhesive may be cured/set after application to form the bond between cover assembly 12 and base assembly 456 using a curing system shown as ultra-violet curing system UV. See FIG. 6D.

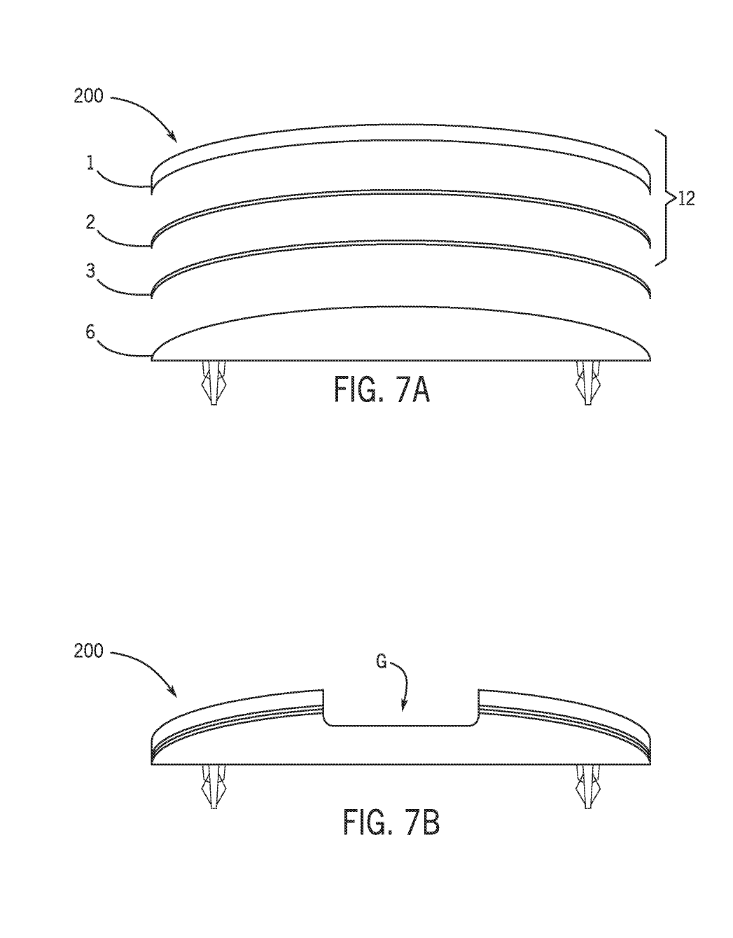

According to an exemplary embodiment as shown schematically in FIGS. 7A and 7B, a component for a vehicle interior 200 may comprise a surface intended to be visible to an occupant when the component is installed in the vehicle interior. Component 200 may comprise a base 6, an adhesive 3 and a cover 12 comprising an outer layer 1. Cover 12 may comprise an inner layer 2. Base 6 may comprise a decorative base. Cover 12 may be coupled to decorative base 6 by adhesive 3. Adhesive 3 may be configured to transmit light passing from cover 12 to decorative base 6. Decorative base 6 may comprise a nonplanar surface. Inner layer 2 of cover 12 and outer layer 1 cover 12 may be nonplanar. Inner layer 2 of cover 12 may be configured to align with the nonplanar surface of decorative base 6. Decorative base 6 may comprise a natural material. Cover 12 may comprise glass. Outer layer 1 of cover 12 may comprise glass. Cover 12 may comprise plastic. Outer layer 1 of cover 12 may comprise plastic. Inner layer 2 of cover 12 may comprise at least a portion configured to prevent visibility of decorative base 6. Inner layer 2 may comprise at least one of (a) an electrical circuit (b) a sensor (c) a capacitive switch (d) a capacitive switch sensor. Cover 12 may comprise an opening or gap G. Opening G may be configured to at least one of (a) expose decorative base 6 or (b) uncover decorative base 6. The surface intended to be visible to an occupant may comprise a first portion comprising cover 12 and a second portion comprising decorative base 6. Decorative base 6 may be configured to provide a visual effect. Cover 12 may be configured to provide a visual effect. The visual effect of decorative base 6 and the visual effect of cover 12 may be configured to provide a composite visual effect.

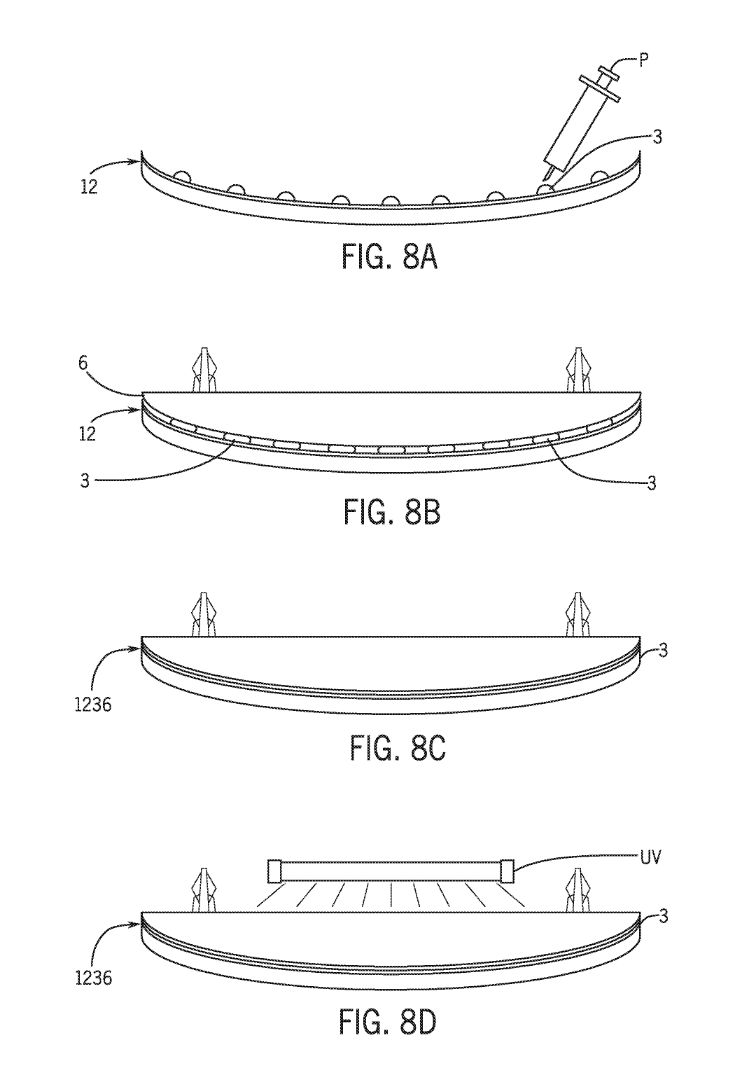

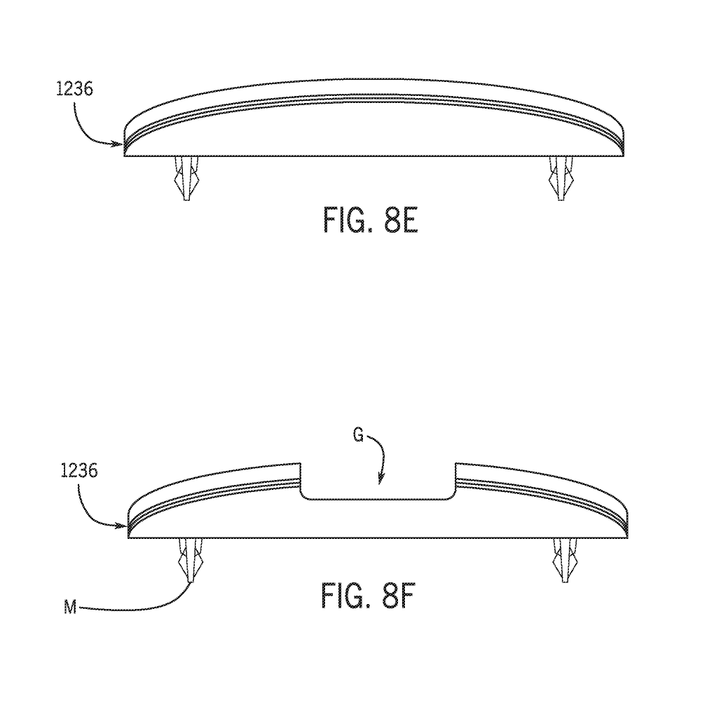

According to an exemplary embodiment as shown schematically in FIGS. 7A and 7B, the component 200 may comprise (in whole or in sections/portions) or multi-layer construction where the cover 1 (with film 2 if used) is bonded to base/substrate 6 by adhesive material shown as adhesive sheet 3. See also FIGS. 8A-8D (e.g. formed component 1236). As shown schematically, the multi-layer construction may comprise a formed (e.g. molded, machined, etc.) gap G or space shown as exposing the material/surface of base 6 (e.g. to provide a functional and/or visual effect) for component 200. See e.g. FIGS. 7B and 8F.

According to an exemplary embodiment as shown schematically in FIGS. 8A-8E, adhesive material 3 applied to attach/bond layers of the component (shown as component 1236) will be actuated/cured (if required) such as by application from an element/system (such as ultra-violet light system UV) to form the multi-layer construction/assembly of the component. See e.g. FIGS. 8E and 8F. See also FIG. 5C (showing heating system H). The formed/contoured shape of the component 1236 (as assembled) may comprise formed/bonded layers conforming to the design/intent of the component. See also FIGS. 2B, 3B, 9A and 15B.

According to an exemplary embodiment as shown schematically in the FIGURES, the component is configured to be installed/mounted (and integrated) in the vehicle interior (e.g. using mounting elements shown schematically as elements M). The multi-layer construction of the component may provide a structure with a visual effect provided by the decorative layer/sheet material conformed between the cover and the base/substrate; as shown schematically the component may be provided with the visual effect of the material (e.g. wood, etc.) of the decorative layer/sheet visible through the transparent section/body of the cover. See e.g. FIGS. 9A-9C.

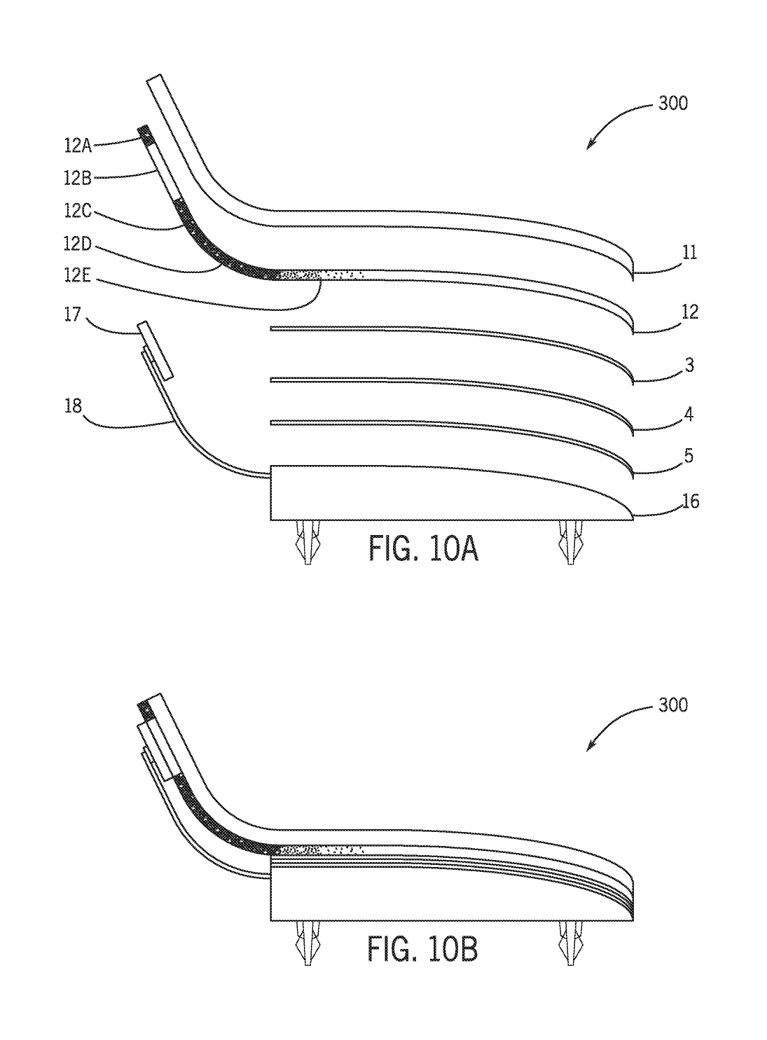

According to an exemplary embodiment as shown schematically in FIGS. 9A-9C and 10A, a component for a vehicle interior 300 may comprise a surface intended to be visible to an occupant when the component is installed in the vehicle interior. Component 300 may comprise a base 16, a decorative layer or laminate 4 and a cover 1112 comprising an outer layer 11. Cover 1112 may comprise an inner layer 12. Decorative layer 4 may be coupled to base 16. Decorative layer 4 may be laminated to base 16, or an adhesive 5 may couple decorative layer 4 and base 16. Cover 1112 may be coupled to decorative layer 4. Adhesive 3 may couple cover 1112 to decorative layer 4. Adhesive 3 may be configured to transmit light passing from cover 1112 to decorative layer 4. Decorative layer 4 may comprise a laminate. Base 16 may comprise a nonplanar surface. Inner layer 12 of cover 1112 and outer layer 11 of cover 1112 may be nonplanar. Inner layer 12 of cover 1112 may be configured to align with the nonplanar surface of base 16. Decorative layer 4 may comprise a natural material. Cover 1112 may comprise glass. Outer layer 11 of cover 1112 may comprise glass. Cover 1112 may comprise plastic. Outer layer 11 of cover 1112 may comprise plastic. Inner layer 12 of cover 1112 may comprise at least a portion configured to prevent visibility of decorative layer 4. Inner layer 12 of cover 1112 may comprise at least one of (a) ink 12A, 12C, 12D, 12E (b) paint 12A, 12C, 12D, 12E (c) a foil 12A, 12C, 12D, 12E (d) a film 12A, 12C, 12D, 12E configured to prevent illumination to pass from a display 17 to outer layer 11 of cover 1112. Inner layer 12 of cover 1112 may comprise at least a portion 12B configured to allow illumination to pass from display 17 to outer layer 11 of cover 1112. Inner layer 12 may comprise at least one of (a) an electrical circuit (b) a sensor (c) a capacitive switch (d) a capacitive switch sensor. Decorative layer 4 may be configured to provide a visual effect. Cover 1112 may be configured to provide a visual effect. The visual effect of decorative layer 4 and the visual effect of cover 1112 may be configured to provide a composite visual effect.

According to an exemplary embodiment as shown schematically in FIGS. 9A and 10A, a component for a vehicle interior 300 may provide a composite visual effect. Component 300 may comprise a base 16, a decorative layer 4 and a cover 1112. Decorative layer 4 may provide a visual effect. Decorative layer 4 may be coupled to base 16. Cover 1112 may provide a visual effect. Cover 1112 may be coupled over decorative layer 4. The composite visual effect may be provided by the visual effect of decorative layer 4 and the visual effect of cover 1112. Base 16 may comprise a nonplanar surface. Cover 1112 may comprise an inner surface 12 and an outer surface 11. The inner surface 12 of cover 1112 and the outer surface 11 of cover 1112 may be nonplanar. The inner surface 12 of cover 1112 may be configured to align with the nonplanar surface of base 16. The outer surface 11 of cover 1112 may comprise at least one of (a) glass, (b) plastic. Cover 1112 may comprise a nonplanar form. Decorative layer 4 may be laminated to base 16. Decorative layer 4 may comprise a sheet. Component 300 may comprise an adhesive 3 configured to couple decorative layer 4 to cover 1112. Adhesive 3 may be configured to transmit light from cover 1112 to decorative layer 4. The visual effect of cover 1112 may comprise at least one of: (a) transparent; (b) translucent; (c) opaque; (d) paint; (e) coating; (f) gradient; (g) transition; (h) shading; (i) material of construction; (j) plastic; (k) molded plastic; (l) contour; (m) surface effect; (n) contour shape; (o) nonplanar shape; (p) speckling; (q) partially transparent; (r) partially translucent; (s) partially opaque. The visual effect of decorative layer 4 may comprise at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral. The visual effect of cover 1112 may comprise a transition between two visual effects. Cover 1112 may comprise a film 12. Film 12 may comprise at least a portion configured to absorb light from a display 17.

According to an exemplary embodiment as shown schematically in FIGS. 9A-9C, component 300 may comprise a multi-layer/multi-section construction providing the physical form/shape and multiple visual effects (e.g. facilitation, aesthetic integration) for the vehicle interior. As shown schematically, the component 300 is provided with a cover 1112 that provides/define the form/shape (e.g. molded plastic, glass, polymer, etc. material) over a sheet material shown as laminate 4 that provides/defines the general visual effect (e.g. natural/authentic material such as wood with visible texture/grain appearance through transparent section/body of cover) on the base/substrate structure. See FIG. 9A. According to an exemplary embodiment as shown schematically in FIGS. 9A-9C and 10A, the cover 1112 comprises a generally transparent body section 12F and other sections such as transparent section 12B for display 17 and opaque sections 12A, 12C, 12D and transition/speckled sections 12E. See FIG. 9A. As indicated schematically in FIGS. 9A-9C, the sheet material shown as laminate sheet 4 and the cover as comprised/formed with multiple sections (e.g. generally transparent, transition/speckled, opaque/colored, etc.) may combine to provide a composite visual effect (e.g. blended, integrated, sectioned, etc.) for the component shown as component 300. See also FIGS. 10A-10B, 11A-11B, 12A-12D and 13A-13D. As shown schematically in FIGS. 10A and 10B, the component of multi-layer/multi-section construction may provide a structure 18 with a display panel 17 (e.g. visible through a transparent section 12B of the cover). See also FIGS. 1B and 2A-2B.

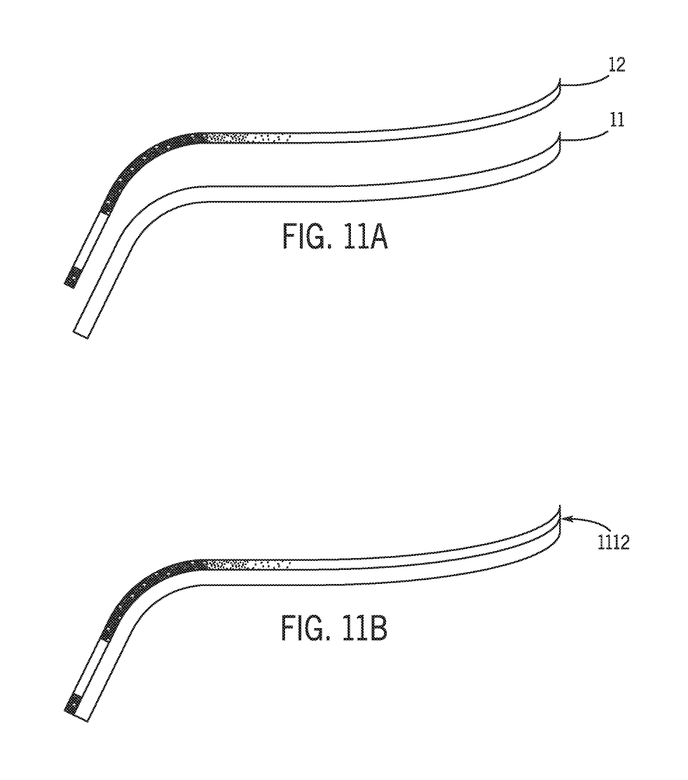

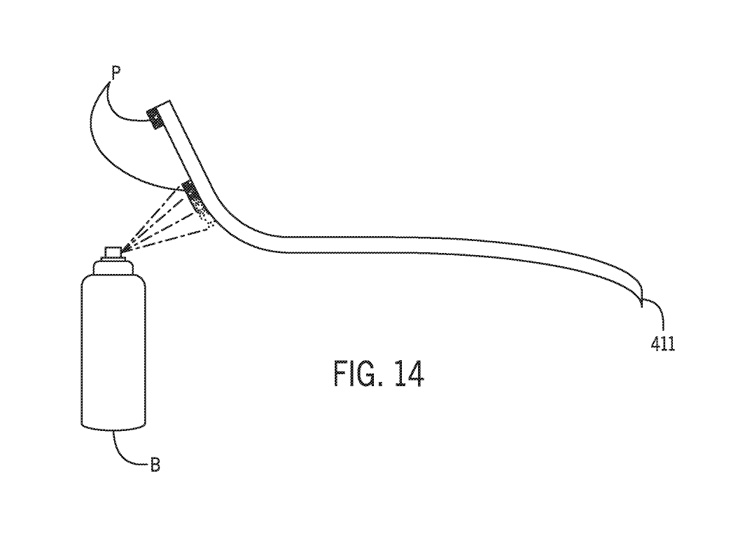

According to an exemplary embodiment as shown schematically in FIGS. 11A through 13D, a method of manufacturing a vehicle trim component may comprise the steps of providing a base 16, joining a decorative layer 4 to base 16 to create a decorative base 4516 and joining a cover 1112 to decorative layer 4. At least a portion of cover 1112 may be configured to allow illumination to pass from cover 1112 to decorative base 4516. The method may comprise the step of applying at least one of (a) ink (b) paint (c) a foil (d) a film to an inner surface 12 of cover 1112 to create a cover assembly 1112 comprising a transparent portion and a partially opaque portion. Cover 1112 may comprise an inner layer 12 and an outer layer 11. At least a portion of inner layer 12 of cover 1112 may be configured to transmit light passing from a display to outer layer 11 of cover 1112. The method may comprise the step of applying at least one of (a) ink (b) paint (c) a foil (d) a film to outer layer 11 to create inner layer 12. At least a portion of inner layer 12 may be configured to prevent transmission of light passing from outer layer 11 to decorative base 4516. The method may comprise the step of applying coating to at least a portion of cover 1112 to create a visual effect as shown schematically in FIG. 14. Inner layer 12 of cover 1112 may comprise at least one of (a) an electrical circuit (b) a sensor (c) a capacitive switch (d) a capacitive switch sensor. Joining cover 1112 to decorative layer 4 may comprise applying an adhesive 3 to at least one of (a) cover 1112 or (b) decorative layer 4. Adhesive 3 may be configured to allow illumination to pass from cover 1112 to decorative base 4516. The method may comprise the step of creating an opening in cover 1112. The opening may be configured to at least one of (a) expose decorative base 4516 (b) uncover decorative base 4516.

According to an exemplary embodiment as shown schematically in FIGS. 11A, 11B and 14, the visual effect/structure at the cover of the component may be provided by a layer/material shown as sheet material or by application of a material layer (such as coating, paint, enamel, lacquer, etc.) by an applicator or dispenser (shown as spray dispenser B); as shown schematically the layer or coating may be applied in a manner to create multiple sections/transitions with opaque and/or transparent and/or translucent areas to provide an intended visual effect through cover (e.g. with laminate).

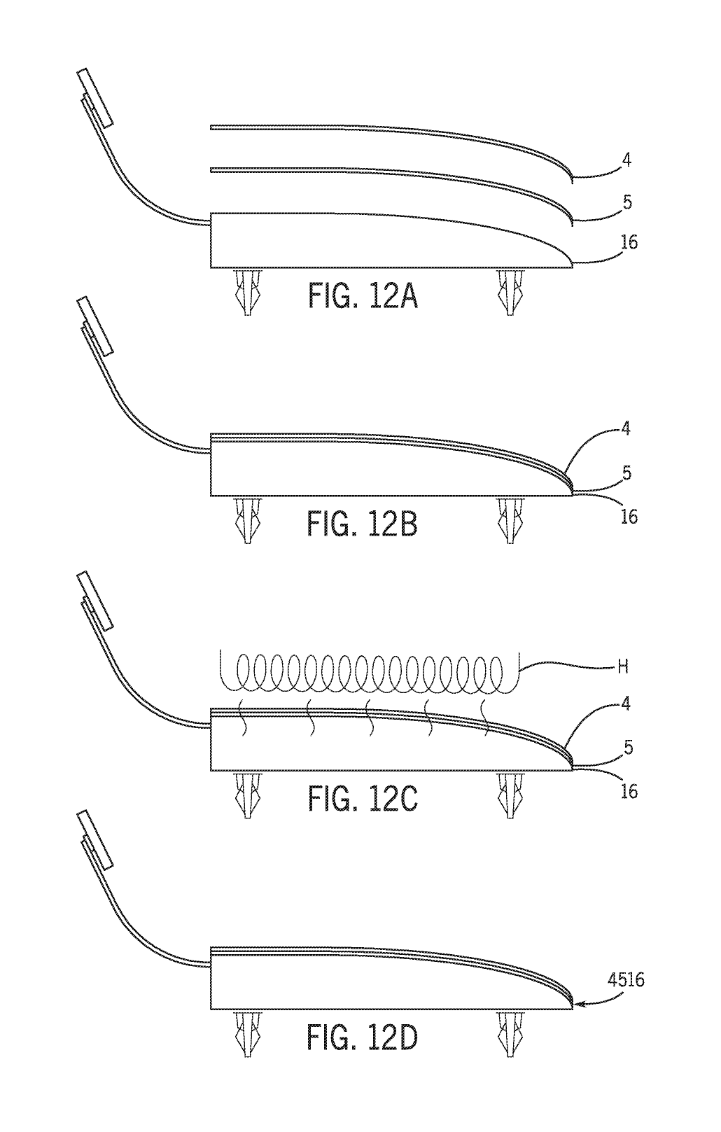

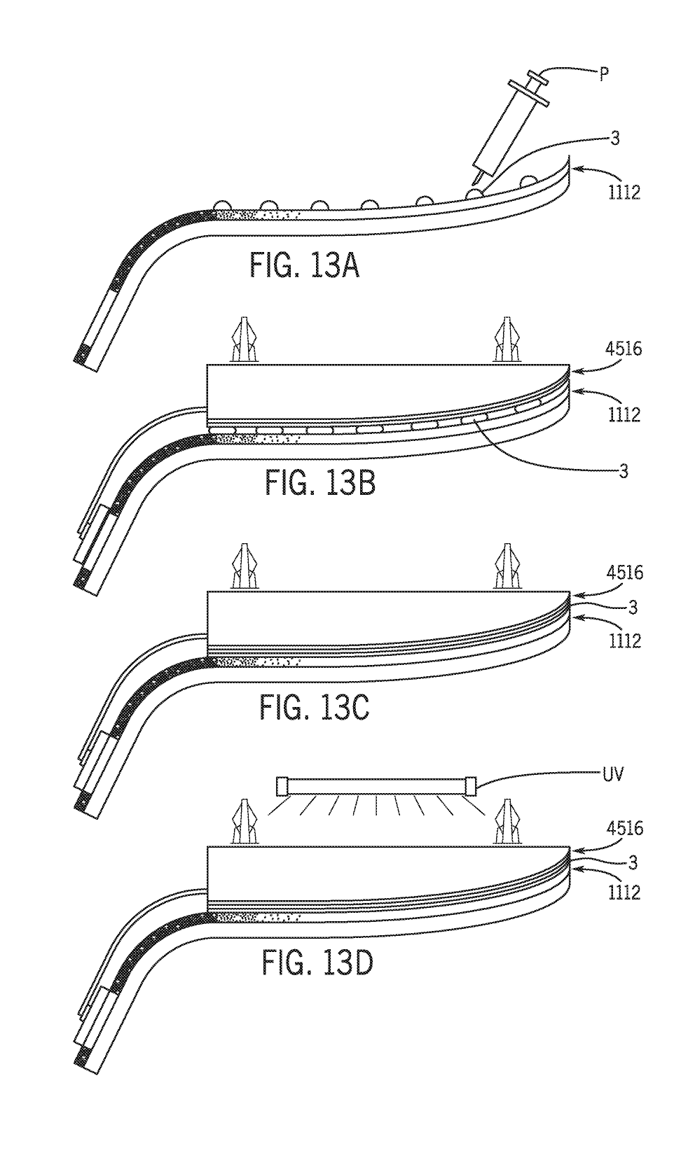

As indicated schematically in FIGS. 12A-12D, the laminate sheet 4 is bonded to the base/substrate 16 by an adhesive (shown as adhesive sheet/tape or strip 5) that may be activated and/or cured (e.g. by application of heat from heating element H) to form a base assembly 1415 for application of the cover/cover assembly 1112 (see FIGS. 9B and 11B) bonded by an adhesive (shown as liquid adhesive 3) that may be activated and/or cured by application of ultra-violet light (e.g. from system UV) to form the component (e.g. cover assembly on base assembly). See also FIGS. 13A-13D.

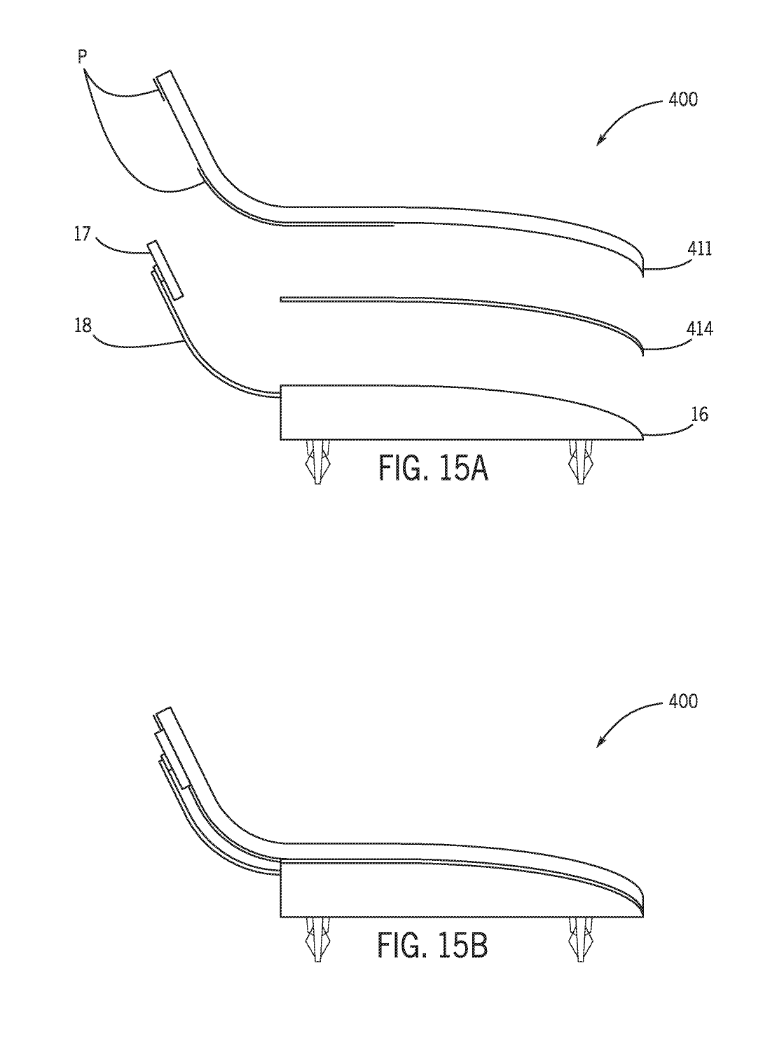

According to an exemplary embodiment as shown schematically in FIGS. 14, 15A and 15B, a component 400 may comprise an outer layer/cover shown as formed structure 411 with a coating shown as paint P applied (e.g. from dispensing system B); cover/structure 411 with coating P may be bonded to a sheet material shown as laminate 414 (e.g. by suitable bonding/attachment) and may be attached/bonded to the base or substrate/structure 16 to form the component 400. As shown schematically, the visual effect or appearance of the component 400 may be a composite effect of the appearance/form of the cover 411 with coating P (e.g. inner layer) and appearance of the laminate/sheet material 414 (e.g. visible through transparent/translucent sections of the cover). See FIGS. 15A-15B. See also FIGS. 9A-9C. According to an exemplary embodiment as indicated schematically in FIGS. 15A and 15B, the component 400 may provide a display panel 17 on structure 18 of base 16 visible at cover 411 (e.g. through a transparent section on cover). As shown schematically, lighting beneath cover (e.g. from base) may be made visible through transparent/translucent sections provided in the cover (see FIG. 9A).

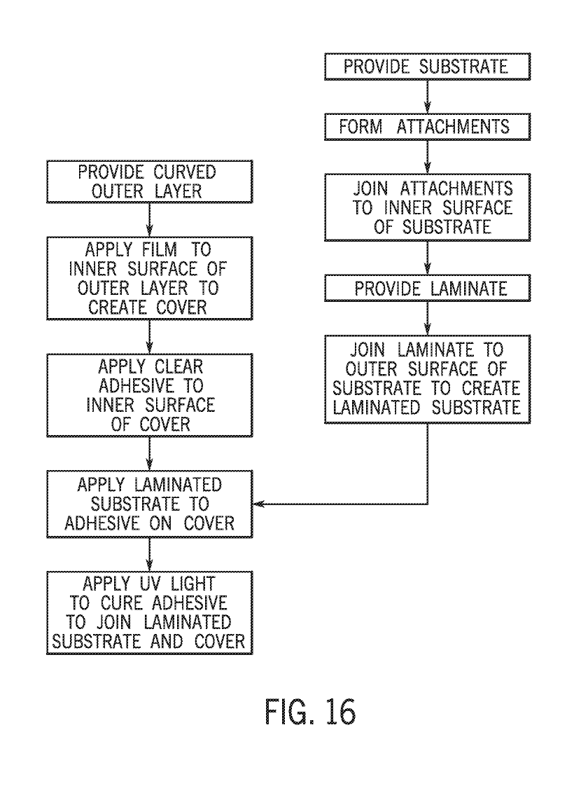

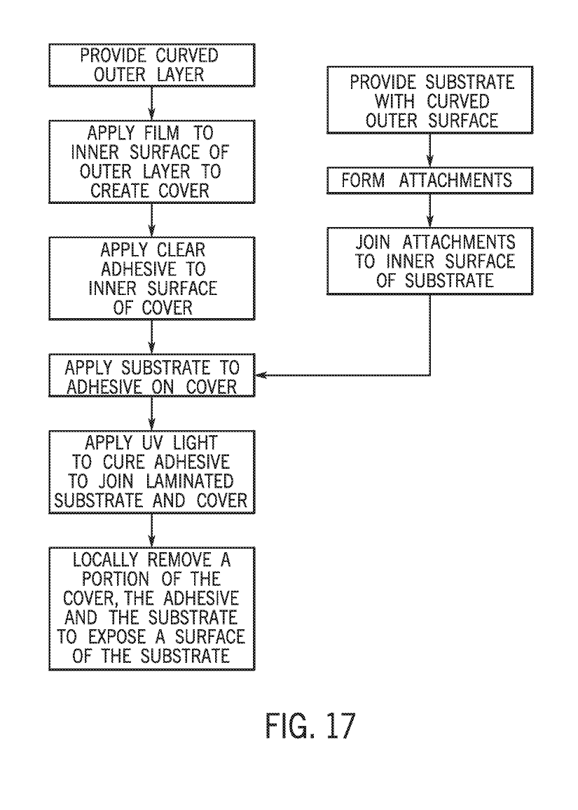

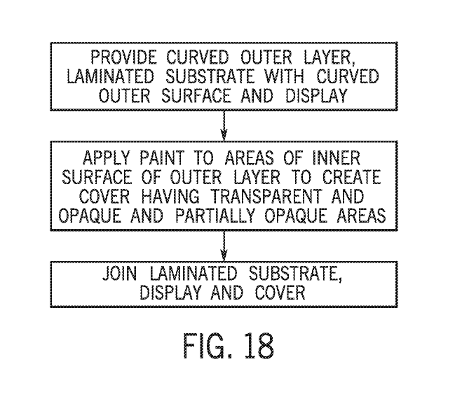

Methods of producing the component are shown schematically according to an exemplary embodiment in FIGS. 16-18.

According to an exemplary embodiment, a component for a vehicle interior may provide a form and a composite visual effect. The component may comprise a base, a material layer providing a visual effect and coupled to the base and a cover assembly providing a visual effect and coupled over the material layer; the composite visual effect may be provided by the visual effect of the material layer and the visual effect of the cover assembly. The base may comprise a nonplanar surface and the cover assembly may comprise an inner surface and an outer surface; the inner surface of the cover assembly and the outer surface of the cover assembly may be nonplanar. The inner surface of the cover may be configured to align with the nonplanar surface of the base. The base may be nonplanar. The material layer may be laminated to the base. The component may comprise an adhesive configured to couple the material layer to the cover assembly. The adhesive may be configured to transmit light from the cover assembly to the material layer. The outer surface may comprise at least one of (a) glass or (b) plastic. The visual effect of the cover assembly may comprise at least one of: (a) transparent; (b) translucent; (c) opaque; (d) paint; (e) coating; (f) gradient; (g) transition; (h) shading; (i) material of construction; (j) plastic; (k) molded plastic; (l) contour; (m) surface effect; (n) contour shape; (o) nonplanar shape; (p) speckling; (q) partially transparent; (r) partially translucent; (s) partially opaque. The visual effect of the material layer may comprise at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral, etc. The visual effect of the cover assembly may comprise a transition or gradient (e.g. sharp or gradual) between two visual effects.

According to an exemplary embodiment, a component for a vehicle interior may provide a form and a composite visual effect. The component may comprise a base, a laminate sheet providing a visual effect and coupled to the base and a cover assembly providing a visual effect and coupled over the laminate sheet; the composite visual effect may be provided by the visual effect of the laminate sheet and the visual effect of the cover assembly.

According to an exemplary embodiment, a component for a vehicle interior may comprise a surface intended to be visible to an occupant when the component is installed in the vehicle interior. The component may comprise a substrate, a decorative layer coupled to substrate and a cover coupled to the decorative layer comprising an outer layer and a film. The decorative layer may comprise a laminate comprising a natural material. The substrate may comprise a nonplanar surface and the cover may comprise an inner surface and an outer surface; the inner surface of the cover and the outer surface of the cover may be nonplanar. The inner surface of the cover may be configured to align with the nonplanar surface of the substrate; the substrate may be nonplanar. The laminate may be laminated to the substrate. The component may comprise an adhesive configured to couple the laminate to the cover; the adhesive may be configured to allow illumination to pass from the cover to the laminate. The outer layer may comprise at least one of (a) glass or (b) plastic. The film may comprise at least a portion configured to prevent illumination to pass from the display to the cover. See generally FIGURES.

### Materials/Construction

According to an exemplary embodiment, the method comprises use of thin laminates of authentic materials to provide the look of the authentic materials without the cost and mass of using machined blocks of the authentic materials. See e.g. FIGS. 3A-3B, 9A-9C, 14, 15A-15C and 16-18.

According to an exemplary embodiment, a layer (e.g. laminate, laminate sheet, strip, sheet, composite, layer, etc.) of the authentic material (or visual environment) may be laminated to base or substrate to form the component; the component may provide or contain attachments, mounting features and any other necessary features required for normal component operation. See e.g. FIGS. 3A-3B, 9A-9C, 14, 15A-15C and 16-18.

### Outer Layer

According to an exemplary embodiment, the outer layer may be made of glass or plastic. Plastic outer layers may be made of vacuum formed acrylic or cast urethane. The layer may be clear or tinted (not opaque). It is typically desired to provide the outer layer have a contoured or curved surface for styling and harmony with other parts of the vehicle interior. See e.g. FIGS. 3A-3B, 9A-9C, 14, 15A-15C and 16-18.

### Inner Layer or Film

According to an exemplary embodiment, when the outer layer is made of glass, a clear or tinted film is applied to the glass for safety. In the event of a shattering or breaking of the glass, the film prevents shards of the glass from separating away. See e.g. FIGS. 3A-3B, 9A-9C, 14, 15A-15C and 16-18.

According to an exemplary embodiment, the film may also be designed to provide decoration or to make certain areas of the outer layer opaque or blacked out. See e.g. FIGS. 3A-3B, 9A-9C, 14, 15A-15C and 16-18.

### Assembly of Film and Outer Layer to Create a Cover

According to an exemplary embodiment, depending on the material used for the outer layer, multiple methods may be used to assemble the film and the outer layer to create a cover. See e.g. FIGS. 16-18.

According to an exemplary embodiment, when the outer layer is made of plastic, the following methods may be used: in mold decoration; in mold lamination; printing ink on the interior surface of the outer layer, or a portion; spraying ink on the interior surface of the outer layer, or a portion. See e.g. FIGS. 3A-3B, 9A-9C, 14, 15A-15C and 16-18.

According to an exemplary embodiment, when the outer layer is made of glass, the film may be adhered to the interior surface of the glass using pressure and a bladder that is used to push any air gaps between the film and the glass to the periphery of the film and ultimately away from the film and the glass. See e.g. FIGS. 3A-3B, 9A-9C, 14, 15A-15C and 16-18.

### Assembly of Laminate and Base

According to an exemplary embodiment, an adhesive may be used to assemble the laminate to the base; heat and pressure may be used in the process; the laminate is thin and flexible enough to conform to the contour of the base. See e.g. FIGS. 3A-3B, 9A-9C, 14, 15A-15C and 16-18.

### Assembly of Cover to Laminated Base

According to an exemplary embodiment, an optically clear adhesive may be used to assemble the cover to the laminated base to ensure the laminate is visible to vehicle occupants. See e.g. FIGS. 3A-3B, 9A-9C, 14, 15A-15C and 16-18.

According to an exemplary embodiment, the component may be formed with a base made from an authentic material such as wood, metal, stone, etc. attached or bonded to a cover (e.g. clear/transparent cover or layer). Material of the cover and the base may then be machined away to expose the authentic material just below the surface of the cover. The component provides an occupant to experience the touch and feel of the authentic material. According to an exemplary embodiment, in providing the component the machined areas may be made or formed in various shapes or patterns (e.g. decorative shape, patterns, etc.) or may form features in the component such as trays, storage locations or pockets, etc. See e.g. FIGS. 3A-3B, 9A-9C, 14, 15A-15C and 16-18.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

1. A component for a vehicle interior with a surface intended to be visible to an occupant when the component is installed in the vehicle interior comprising:
(a) a base;
(b) a decorative layer coupled to the base; and
(c) a cover coupled to the decorative layer comprising an outer layer and configured to provide a visual effect;
wherein the decorative layer comprises a natural material configured to provide a visual effect;
wherein the cover comprises an inner layer comprising at least a portion configured to prevent visibility of the decorative layer.

2. The component of claim 1 wherein the decorative layer comprises at least one of (a) a laminate; (b) a sheet; (c) a veneer; (d) a film.

3. The component of claim 1 wherein the base comprises a nonplanar surface; wherein an inner layer of the cover and the outer layer of the cover are nonplanar; wherein the inner layer of the cover is configured to align with the nonplanar surface of the base.

4. The component of claim 3 wherein the inner layer of the cover is configured to prevent illumination to pass from a display to the outer layer of the cover; wherein the inner layer of the cover comprises at least one of (a) ink; (b); paint; (c) a foil; (d) a film; (e) a transparent material; (f) a translucent material; (g) a light-transmissive material.

5. The component of claim 1 wherein the cover comprises an opening configured to at least one of (a) expose the decorative layer; (b) uncover the decorative layer.

6. The component of claim 1 further comprising an adhesive configured to couple the decorative layer to the cover; wherein the adhesive is configured to transmit light passing from the cover to the decorative layer; wherein the cover comprises at least one of (a) glass; (b) plastic; (c) a transparent material; (d) a light-transmissive material; (e) an opaque material.

7. The component of claim 1 wherein the surface intended to be visible to an occupant comprises a first portion comprising the cover and a second portion comprising the decorative layer; wherein the visual effect of the decorative layer and the visual effect of the cover are configured to provide a composite visual effect for the surface intended to be visible to the occupant.

8. The component of claim 1 further comprising a cover assembly comprising the cover and an inner layer for the cover providing at least one of (a) an electrical circuit; (b) a sensor; (c) a capacitive switch; (d) a capacitive switch sensor.

9. A component for a vehicle interior with a surface intended to be visible to an occupant when the component is installed in the vehicle interior comprising:
(a) a base;
(b) a decorative layer coupled to the base; and
(c) a cover coupled over the decorative layer comprising an outer layer and configured to provide a visual effect;
wherein the decorative layer is configured to provide a visual effect;
wherein the visual effect of the decorative layer and the visual effect of the cover are configured to provide a composite visual effect for the surface intended to be visible to the occupant.

10. The component of claim 9 wherein the visual effect of the decorative layer comprises at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral.

11. The component of claim 9 wherein the visual effect of the cover comprises at least one of: (a) transparent; (b) translucent; (c) opaque; (d) paint; (e) coating; (f) gradient; (g) transition; (h) shading; (i) material of construction; (j) plastic; (k) molded plastic; (l) contour; (m) surface effect; (n) contour shape; (o) nonplanar shape; (p) speckling; (q) partially transparent; (r) partially translucent; (s) partially opaque.

12. The component of claim 9 wherein the composite visual effect comprises a transition between two visual effects.

13. The component of claim 9 wherein the base comprises a nonplanar surface; wherein the cover comprises an inner surface and an outer surface; wherein the inner surface of the cover and the outer surface of the cover are nonplanar; wherein the inner surface of the cover is configured to align with the nonplanar surface of the base.

14. The component of claim 9 further comprising an adhesive configured to couple the decorative layer to the cover; wherein the adhesive is configured to transmit light from the cover to the decorative layer.

15. The component of claim 9 wherein the cover further comprises a film; wherein the film comprises at least a portion configured to absorb light from a display.

16. A method of manufacturing a vehicle trim component configured to provide a composite visual effect comprising the steps of:
(a) providing a base;
(b) joining a decorative layer to the base to create a decorative base;
(c) joining a cover to the decorative layer;
wherein at least a portion of the cover is configured to allow illumination to pass from the cover to the decorative base;
wherein the composite visual effect is configured to be provided by a visual effect of the decorative layer and a visual effect of the cover.

17. The method of claim 16 further comprising the step of applying to an inner surface of the cover at least one of (a) ink; (b) paint; (c) a foil; (d) a film; (e) a light-transmissive material; (f) a generally opaque material.

18. The method of claim 16 further comprising the step of applying coating to at least a portion of the cover to create the visual effect of the cover.

19. The method of claim 16 wherein the step of joining the cover to the decorative layer comprises applying an adhesive to at least one of (a) the cover and/or (b) the decorative layer; wherein the adhesive is configured to allow illumination to pass from the cover to the decorative base.

20. The method of claim 16 wherein the visual effect of the decorative layer comprises at least one of: (a) composite wood; (b) metal; (c) texture; (d) wood; (e) wood grain; (f) laminate surface; (g) natural material; (h) authentic material; (i) foil; (j) contour; (k) curved edge; (l) fiber; (m) fabric; (n) stone; (o) mineral.
